(19) United States
(12) Patent Application Publication
(10) Pub. No.: US 2025/0341110 A1
(43) Pub. Date: Nov. 6, 2025

(54) TOWER FOR A WIND TURBINE OR A TRANSMITTING AND RECEIVING SYSTEM FOR MOBILE COMMUNICATIONS

(71) Applicant: HOLZTURM GMBH, Hamburg (DE)

(72) Inventor: Gregor Prass, Hamburg (DE)

(21) Appl. No.: 18/700,085

(22) PCT Filed: Oct. 7, 2022
(86) PCT No.: PCT/EP2022/077977

§ 371 Date: Jul. 19, 2024

(30) Foreign Application Priority Data
Oct. 18, 2021 (DE) 10 2021 126 984.9

(51) Int. Cl. E04H 12/04; F03D 13/20

(52) U.S. Cl. CPC E04H 12/04; F03D 13/205

(57) ABSTRACT

The invention relates to a tower for a wind turbine or a mobile radio transceiver system with at least one section with polygonally arranged walls, wherein the walls are formed from a wood-based material, wherein in each case two walls in a corner of the polygon are connected to one another in the form of a vertical joint with in each case one side face. It is advantageous that the side surface of a wall in the vertical joint has at least one connecting element, that the at least one connecting element is suitable for transmitting shear forces in the vertical joint, that the at least one connecting element has at least one projection (prong) and at least one recess (valley), that the at least one projection and the at least one recess are arranged in such a way that the at least one projection of one wall engages in the at least one recess of the other wall in the assembled state of the walls in the vertical joint, and that at least one step is provided between a projection and a recess, wherein the projections of two connecting means of two walls are arranged one above the other in the assembled state of the walls in the vertical joint.

The invention relates to a tower for a wind turbine or a mobile radio transceiver system having at least one section with polygonally arranged walls, the walls being formed from a wood-based material, the two walls in each corner of the polygon are connected to one another in the form of a vertical joint with a side surface in each case.

A wind turbine is a device for generating electrical energy. The wind turbine is equipped with a foundation, a tower that is erected on the foundation and a nacelle that is placed on the tower. The drive unit connected to the rotor blades for generating energy is located on the nacelle. Such wind turbines are known and familiar to those skilled in the art. The nacelle is arranged on the tower of the wind turbine. At its end, the nacelle is in turn equipped with a rotor with a horizontal or vertical axis of rotation, which is coupled to a generator. The use of three-bladed rotors is common, as these ensure relatively uniform running. Such wind turbines are highly developed in terms of the efficiency with which the power of the wind can be utilized. Such towers are known, for example, from DE 10 2015 014 648 A1.

The height of wind turbine towers can vary. In general, it can be stated that the energy yield correlates with the height of the tower of a wind turbine, so that heights of over 100 m and even over 150 m can be achieved. It can therefore be said that there is also an economic correlation between the construction costs incurred and the energy yield, whereby experience has shown that the construction costs incurred increase disproportionately with the height of the wind turbine.

The design of the tower is geared towards the static loads exerted on the tower by the nacelle and the dynamic loads exerted by the rotation of the rotor blades and the movement of the nacelle depending on the wind direction.

Transmission and reception systems for mobile communications—known as base stations—are nodes in a mobile communications network. Each base station supplies a narrowly defined area—the radio cell—with reception. Such systems are known to those skilled in the art. They are located at elevated positions, in particular on masts or towers.

Well-known towers are made of steel rings or concrete elements. From an economic point of view, it is desirable to maximize the height of the towers economically. This applies to wind turbines, for example, because the yield of a wind turbine depends on the hub height of the rotor and the yield increases as the height increases. At the same time, the greater height of the tower increases the demands on the statics and the material or material costs of the tower. The wall thicknesses increase and this increases the construction costs of the tower.

The base surfaces of the known towers are either polygons or ring-shaped circular segments. Polygonal towers made of individual segments of concrete are known from WO 2003/069099 A. These are connected with cement or with tendons. When connecting with tendons, the joints are compressed by prestressing.

It is also known to construct polygonal towers from wood (DE 10 2007 006 652 A1). Polygonal towers made from individual segments of a wood-based material are known from DE 10 2009 048 936 A1. The wall sections are trapezoidal in shape and are connected to each other via connecting means. These are in particular adhesives. It has been shown that towers for wind turbines can be manufactured from wood, which can be used to construct towers for wind turbines cost-effectively, quickly and with material savings. It has proven to be particularly advantageous to manufacture these towers on site from individual components, each of which is connected directly to the neighboring elements using connecting means. Furthermore, one embodiment provides for a falsework to be erected inside the tower, which itself does not contribute to the transfer of the static or dynamic loads of the finished tower. (DE 10 2009 048 936 A1). A coating has proven to be advantageous as protection against environmental influences acting on the surface, in particular moisture (DE 10 2009 017 586 A1).

Connecting the vertical joints is still in need of improvement.

Therefore, the objective of the invention is to improve the vertical butt joints, in particular with regard to the shear transfer between elements connected to each other via the joint.

The objective is solved in that the side surface of a wall in the vertical joint has at least one connecting element, in that the at least one connecting element is suitable for transmitting shear force in the vertical joint, in that the at least one connecting element has at least one projection (prong) and at least one recess (valley), in that the at least one projection and the at least one recess are arranged in such a way that the at least one projection of one wall engages in the at least one recess of the other wall in the assembled state of the walls in the vertical joint, and that at least one step is provided between a projection and a recess, wherein the projections of two connecting means of two walls are arranged one above the other in the assembled state of the walls in the vertical joint.

In this application, steps are to be equated with jumps.

Surprisingly, it has been shown that this enables a particularly efficient shear transmission in the vertical joints between the walls.

A further teaching of the invention provides that at least two steps are provided between a projection and a recess. It has been found to be preferably advantageous that the efficiency for transmitting the shear forces of the corners in the vertical joints is dependent on the number k of steps between the prongs and valleys. This results particularly preferably in k/(k+1).

A further teaching of the invention provides that the length of a step in the vertical joint is half the length of a projection or a recess. This has a beneficial effect on the efficiency of the shear force transmission.

A further teaching of the invention provides that the number of connecting means is evenly distributed over the length of the vertical joint on the side wall.

A further teaching of the invention provides that the wood-based material is laminated veneer lumber

A further teaching of the invention provides that at least one wall of the section has a rectangular shape. Such a shape has essentially no waste.

A further teaching of the invention provides that at least one wall of the section has the shape of a triangle. Advantageously, the triangle is an isosceles triangle. This makes it possible to minimize waste.

A further teaching of the invention provides that the walls are composed of wall sections. Advantageously, the wall sections are rectangular, trapezoidal and/or triangular. It is also advantageous that the wall sections are assembled into segments that form the tower in a superimposed arrangement. This also reduces the wastage over the entire length of the section.

A further teaching of the invention provides that the wall sections are connected to each other to form segments and walls either directly with an adhesive or via further connecting elements, preferably wooden elements, inserted between them.

Embodiments of the invention are explained in more detail below with reference to the drawings. These show:

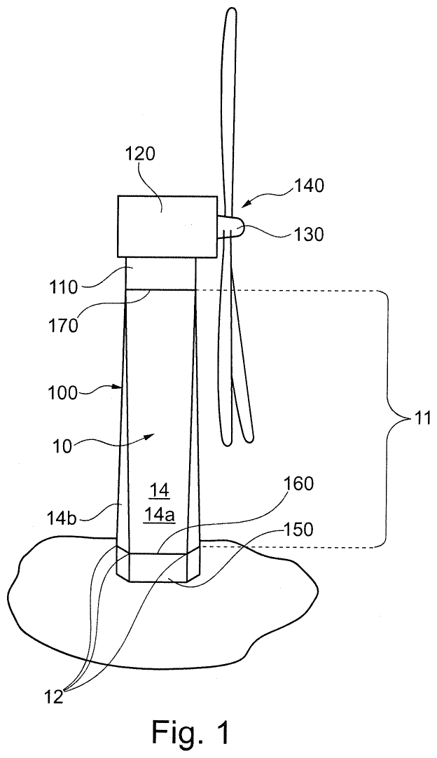

FIG. 1 a schematic spatial representation of a wind turbine with a tower according to the invention,

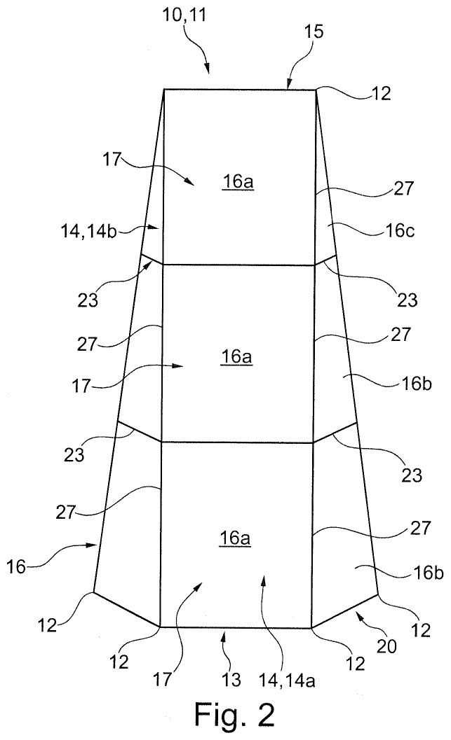

FIG. 2 a schematic spatial representation of an embodiment of a tower according to the invention, and

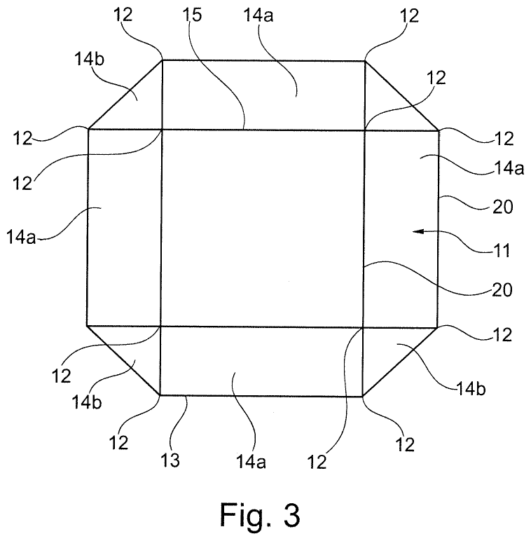

FIG. 3 a top view of FIG. 2.

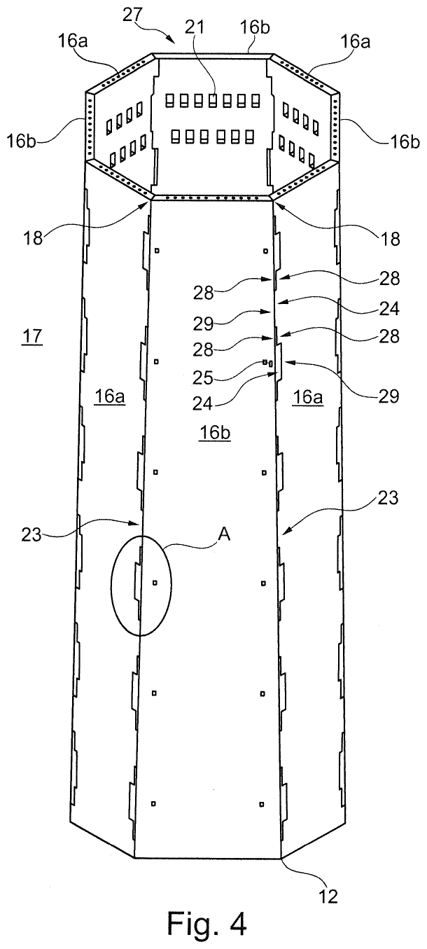

FIG. 4 a spatial view of a segment of a tower according to the invention,

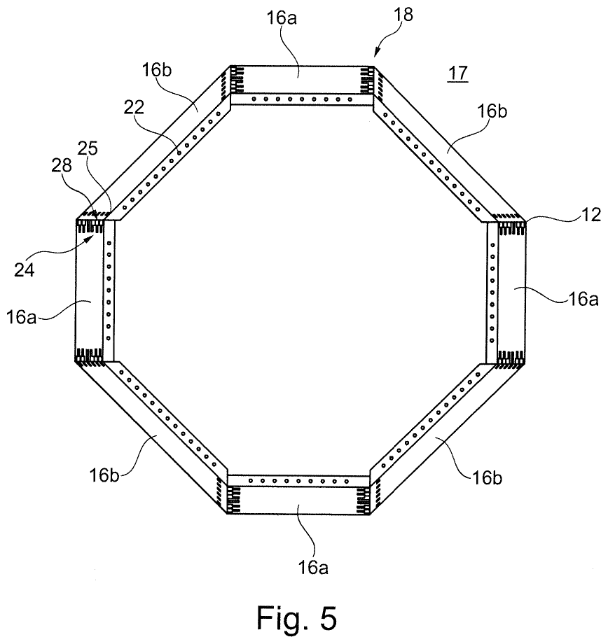

FIG. 5 a top view of FIG. 4,

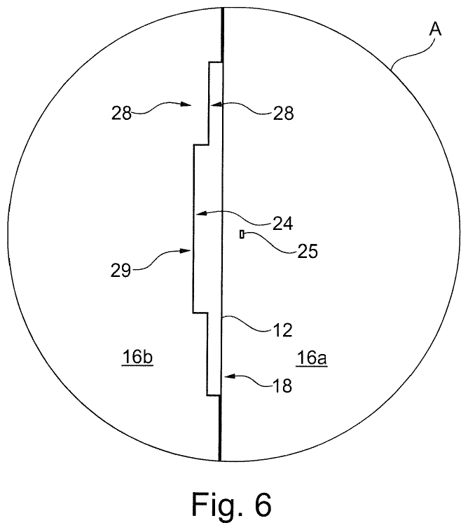

FIG. 6 an enlarged view of FIG. 4,

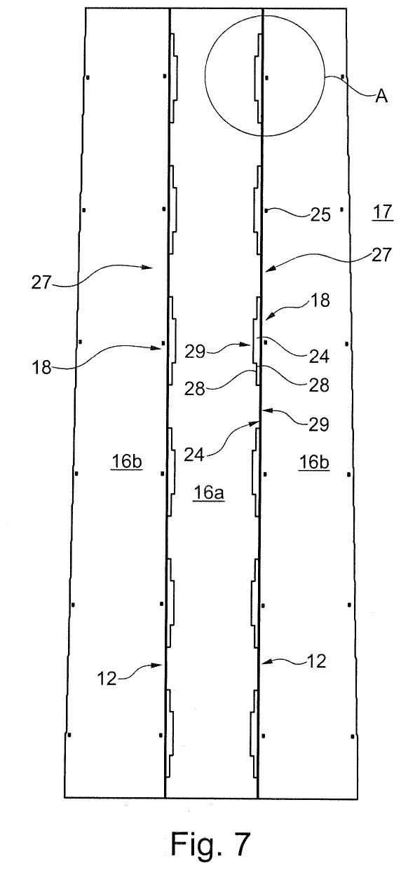

FIG. 7 a side view of FIG. 4,

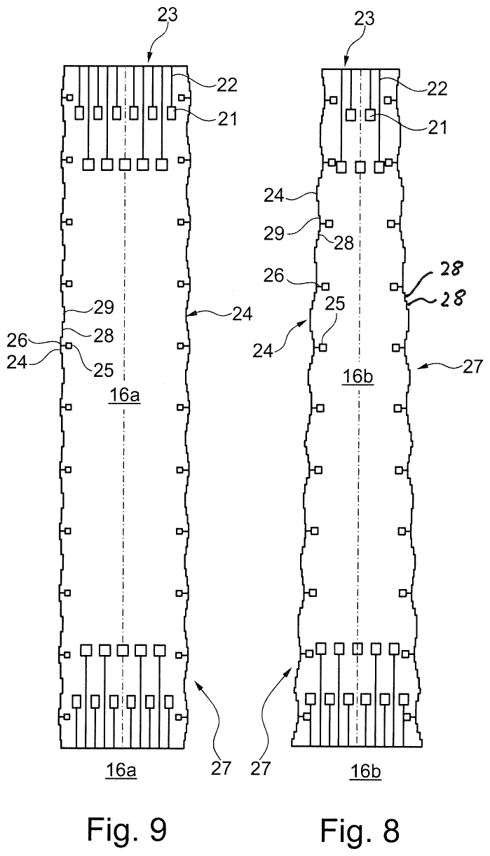

FIG. 8 a side view of a first trapezoidal wall element of FIG. 4,

FIG. 9 a side view of a first rectangular wall element of FIG. 4, and

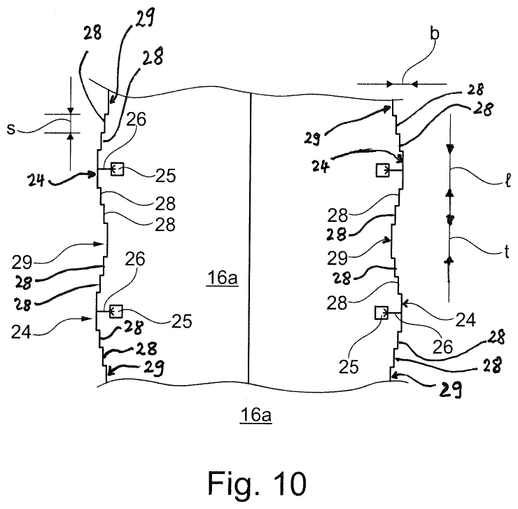

FIG. 10 an enlarged view of FIG. 9.

FIG. 1 shows a spatial view of a wind turbine 100 with a tower 10, which is arranged with its underside 160 on a foundation 150. An adapter 110 is provided on its upper side 170, on which a nacelle 120 is rotatably provided, which has a rotor 140 with a hub 130.

The tower 10 has a cross-section in the shape of a polygon 20 with n corners 12 at its lower end 13. It is composed of individual walls 14, which are arranged polygonally according to the cross-section 20. The walls are made of a wood-based material, for example cross-laminated timber, laminated veneer lumber or the like.

In the embodiment shown in FIG. 1, the tower 10 has one section 11. Alternatively, multiple sections may be provided, of which at least one section is designed according to the invention. At its upper end 15, the polygon 20 of the cross-section of the tower 10 or section 11 preferably has n/2 corners.

In this embodiment, the tower 10 has different walls 14. Alternating rectangular walls 14a and triangular walls 14b, here preferably designed as isosceles triangles, are provided. This makes it possible to halve the number n of corners 12 from the lower end 13 to the upper end 15, so that the polygon 20 only has n/2 corners at the upper end.

Alternatively, the halving of the corners can be omitted so that the side walls 14b are not triangular but trapezoidal.

In the embodiment shown in FIG. 2 and FIG. 3, eight corners are provided in the polygon at the lower end 13, while the upper end 15 has only four corners. However, it is advantageous to provide more corners 12, for example sixteen corners at the lower end 13 and correspondingly eight corners at the upper end 15. Alternatively, the halving of the number of corners can again be omitted here.

For transportation and manufacturing reasons, it is advantageous to divide the walls 14, 14a, 14b into wall sections 16, which have a length of 12.5 m, 15 m or 20 m, for example, and to assemble the walls 14, 14a, 14b from these wall sections 16 on site. For this purpose, it is advantageous, for example, to assemble the wall sections 16 into horizontal segments 17 via corner joints 18 for joining the vertical joints 28 in the corners 12 between the walls 14, 14a, 14b or 16, 16a, 16b, 16c. The segments 17 are then arranged on top of each other to form section 11 or tower 10.

The wall sections 16 are provided as rectangular wall sections 16a to form the walls 14a. Furthermore, trapezoidal wall sections 16b and possibly triangular wall sections 16c, preferably isosceles, are provided to form the triangular walls 14b.

The walls 14, 14a, 14b or the wall sections 16, 16a, 16b, 16c can be connected to each other at their horizontal joints using connecting elements. These can be adhesive or fastening elements such as anchor rods or threaded rods. If adhesive is used, connecting elements such as wooden wedges, metal plates, anchors or similar can also be used.

The tower wall 14, 14a, 14b is the load-bearing element of the tower 100 structure and is responsible for transferring all loads to the foundation 150. In the case of a wind turbine, for example, the resulting normal force due to the bending moment from wind load and operation of the turbine accounts for the largest proportion of the load. Due to the maximum bending moment, the diameter is largest at the base of the tower and tapers upwards towards the nacelle 120 in order to reduce the load and ensure blade clearance of the rotors 140.

In FIG. 4 to FIG. 10, for example, a wooden tower 10 according to the invention is considered in a further embodiment, for example with a height of 100 m.

Due to transportation simplifications in standard trucks, the maximum length per segment 17 can be set at 12.50 m. This results in a total of eight segments 17 of equal length for the wooden tower 10, which are arranged one above the other. These are to be assembled on site on the ground, for example, to form octagon-segments 17 (see FIG. 4, 5) from a corresponding number of plate-shaped wall components 16, 16a, 16b, 16c.

The assembled segments 17 are lifted to their destination in the tower 10 using a heavy-duty crane, for example.

The panel width of the individual wall components can be limited to a maximum width of 2.42 m for transportation reasons. The exact width varies depending on the segment 17 and its installation height in the tower 10.

A single wall element 16b of a segment 17 is shown in FIG. 8. This is trapezoidal in shape and therefore tapers upwards.

A single wall element 16a of a segment 17 is shown in FIG. 9. This is rectangular in shape and therefore maintains a constant width upwards.

FIGS. 8 and 9 show both pockets 21 and threaded rods 22 of the horizontal joints 23, but also vertical joints 28 of the wall elements 16a, 16b consisting of prongs 24, steps 28 and valleys 29 and pockets 25 with threaded rods 26.

The horizontal joints 23, which are used to assemble the individual polygonal segments 16 on top of each other, are made with pre-stressed threaded rods 22. For this purpose, pockets 22 are milled into the inside of the tower walls 16, for example to a depth of 90% of the wall thickness, in the upper and lower wall element 16 in the manufacturing plant. The threaded rods 22 can be inserted around the outer wall via a circular arrangement (not shown). Precisely fitting load distribution plates (not shown), for example made of steel, are also inserted into the pockets to ensure better force transmission into the wood-based material, for example laminated veneer lumber. In order to accommodate the statically required number of threaded rods 22 without weakening the cross-section too much, two staggered layers of pockets 21 are selected. The required number is determined by the structural analysis.

A wall element 16a is shown as an example in FIG. 10. The prongs 24, steps 28 and valleys 29 of the vertical joints 28 are arranged in such a way that they are compatible with those of wall element 16b.

The arrangement of the vertical threaded rods 26 must be checked in detail. These are only used to pull the wall elements 16a, 16b together during assembly. They do not fulfill any static requirements.

The vertical joints 27 primarily serve to transfer the shear forces resulting from horizontal stress. For this reason, the vertical wall joints of the vertical joints 28 are designed in the form of prongs according to the invention in order to be able to ideally absorb the resulting shear forces. The length 1 of the prongs 24, the position t of the valleys 29 and the length s of the steps 28 are determined by the selected number of prongs 24 over the total length of the wall elements 16a, 16b.

The prongs 24 must be alternately arranged for the wall elements 16a and 16b so that they interlock in the corresponding valleys 29. When milling, the angle of inclination of the tower and, if necessary, minimal clearance for better assembly must be taken into account.

The maximum width b of the prongs 24, steps 28 and valleys 29 is determined once for one wall thickness and converted accordingly to a different wall thickness.

For a wall thickness of 30 cm, for example, this can result in a width b of 6 cm.

The prongs 24 are preferably designed with steps 28 in order to obtain a more favorably load-bearing shear length. According to the invention, the number of steps is greater than or equal to 2. The greater the load in the vertical joints, the higher the number of steps 28 has been shown to be.

It has been found to be geometrically particularly preferable that the length 1 of the prongs 24 corresponds to the length t of the valleys 29 and the length s of the steps is half the length of each of these. In this way, the prongs later fit particularly well into the valleys.

The following relationships are preferred:

The axis length is determined by:

axis length=vertical joint seam length/(2*number of prongs)

The prong length l, or valley length t, is calculated as follows:

l=t=axis length/2

The length of the individual steps results in:

s=axis length/4

The vertical joints 28 are also made using threaded rods 26 in milled pockets 25. These have purely structural requirements and are used to firmly pull the joints together. They are not used to transfer forces.

A threaded rod 26, for example with a diameter of 20 mm, a length of 30 cm and a steel plate for load distribution is attached to each pocket 25. The embedding length per wall is 10 cm. A further 5 cm is required in each pocket to screw on the nut, as well as for the washer and the load distribution plate.

The threaded rods 26 are particularly necessary when the assembled segments 17 are lifted by the crane, as additional vertical dead weight loads 26 must be transferred via the threaded rods at this point. As soon as the segments 17 are bolted into the horizontal joints 23, the structure braces itself.

Furthermore, it has preferably been found that the efficiency for transmitting the shear forces of the corners in the vertical joints 28 is dependent on the number k of steps 28 between prongs 24 and valleys 29. This results particularly preferably in k/(k+1).

1-10. (canceled)

11. Tower for a wind turbine or a mobile radio transceiver system, comprising;
at least one section with polygonal walls, the walls made of a wood-based material, wherein the two walls in each corner of the polygon are connected to one another by a vertical joint including a side face;
at least one connecting element in the side faces of a wall in the vertical joint wherein the at least one connecting element is configured to transmit shear forces in the vertical joint;
at least one projection and at least one recess, in the at least one connecting element wherein the at least one projection of one wall engages in the at least one recess of the other wall in the vertical joint; and,
at least one step between a projection and a recess, wherein the projections of two connecting elements of two walls are disposed one above the other in the vertical joint.

12. Tower according to claim 11, further comprising at least two steps between a projection and a recess.

13. Tower according to claim 12, wherein the length of a step in the vertical joint is half the length of at least one of a projection or a recess.

14. Tower according to claim 11, wherein the number of connecting elements is evenly distributed over the length of the vertical joint on the side wall.

15. Tower according to claim 11, wherein the wood-based material is laminated veneer lumber.

16. Tower according to claim 11, wherein at least one wall of the section is a rectangular shape.

17. Tower according to claim 11, wherein at least one wall of the section is at least one of a triangular or trapezoidal shape.

18. Tower according to claim 11, wherein the walls are composed of wall sections.

19. Tower according to claim 11, wherein the wall sections are at least one of rectangular, trapezoidal and/or triangular.

20. Tower according to claim 11, wherein the wall sections are assembled into superimposed segments.
